(19) United States
(12) Patent Application Publication
(10) Pub. No.: US 2025/0271616 A1
(43) Pub. Date: Aug. 28, 2025

(54) RING RESONATOR AND ITS MANUFACTURING METHOD

(71) Applicant: NEC Corporation, Tokyo (JP)

(72) Inventor: Ryo MARUYAMA, Tokyo (JP)

(73) Assignee: NEC Corporation, Tokyo (JP)

(21) Appl. No.: 19/019,699

(22) Filed: Jan. 14, 2025

(30) Foreign Application Priority Data
Feb. 22, 2024 (JP) 2024-025796

(51) Int. Cl. G02B 6/293; G02F 1/01

(52) U.S. Cl. CPC G02B 6/29338; G02F 1/0113; G02F 1/0147; G02F 2203/15

(57) ABSTRACT

A ring resonator in which a nonlinear effect is prevented from becoming apparent, and a method for manufacturing such a ring resonator are provided. A ring resonator according to the present disclosure includes an input waveguide, an output waveguide, and a ring waveguide including a first waveguide part optically connected to the input waveguide, a second waveguide part optically connected to the output waveguide, two curved waveguide parts each connecting the first and second waveguide parts to each other, and a heater disposed along a third waveguide part, the third waveguide part being a longer one of the two waveguide parts. Lengths of the two waveguide parts are different from each other. A first direction along the first waveguide part and a second direction along the second waveguide part are not parallel to each other.

### INCORPORATION BY REFERENCE

This application is based upon and claims the benefit of priority from Japanese patent application No. 2024-025796, filed on Feb. 22, 2024, the disclosure of which is incorporated herein in its entirety by reference.

### TECHNICAL FIELD

The present disclosure relates to a ring resonator and its manufacturing method.

### BACKGROUND ART

Patent Literature 1 discloses a technology for realizing an optical filter by using a ring resonator and a heater.

Patent Literature 1: Published Japanese Translation of PCT International Publication for Patent Application, No. 2022-522796

### SUMMARY

Patent Literature 1 does not mention anything in regard to the suppression of any occurrence of a nonlinear phenomenon in a ring resonator, so there is a risk that a nonlinear effect may become apparent.

The present disclosure has been made in order to solve such a problem, and an object thereof is to provide a ring resonator in which a nonlinear effect is prevented from becoming apparent, and to provide a method for manufacturing such a ring resonator.

A ring resonator according to the present disclosure includes:
an input waveguide;
an output waveguide; and
a ring waveguide including a first waveguide part optically connected to the input waveguide, a second waveguide part optically connected to the output waveguide, and two curved waveguide parts each connecting the first and second waveguide parts to each other, in which
lengths of the two waveguide parts are different from each other, the ring resonator further includes a heater disposed along a third waveguide part,
the third waveguide part being a longer one of the two waveguide parts, and
a first direction along the first waveguide part and a second direction along the second waveguide part are not parallel to each other.

A method for manufacturing a ring resonator according to the present disclosure includes:
forming an input waveguide, a ring waveguide, and an output waveguide; and
forming a heater, in which
the ring waveguide includes a first waveguide part optically connected to the input waveguide, a second waveguide part optically connected to the output waveguide, and two curved waveguide parts each connecting the first and second waveguide parts to each other,
lengths of the two waveguide parts are different from each other, a first direction along the first waveguide part and a second direction along the second waveguide part are not parallel to each other; and
the heater is formed along a third waveguide part, the third waveguide part being a longer one of the two waveguide parts.

According to the present disclosure, it is possible to provide a ring resonator in which a nonlinear effect is prevented from becoming apparent, and to provide a method for manufacturing such a ring resonator.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic plan view of a ring resonator according to the present disclosure;

FIG. 2 is a schematic cross-sectional view of the ring resonator according to the present disclosure;

FIG. 3 is a schematic cross-sectional view of the ring resonator according to the present disclosure;

FIG. 4 is a schematic plan view of a ring resonator according to the present disclosure; and

FIG. 5 is a flowchart showing a method for manufacturing a ring resonator according to the present disclosure.

### EXAMPLE EMBODIMENT

### First Example Embodiment

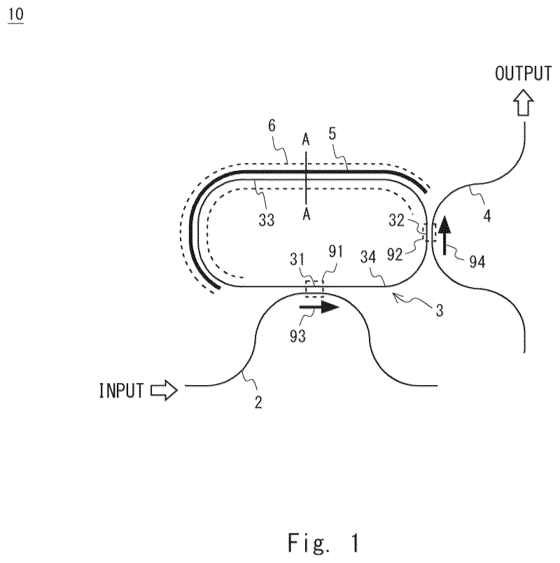

A configuration of a ring resonator 10 will be described hereinafter with reference to FIG. 1. FIG. 1 is a schematic plan view of the ring resonator 10. The ring resonator 10 includes an input waveguide 2, a ring waveguide 3, an output waveguide 4, a heater 5, and a thermal insulation structure 6.

Each of the input waveguide 2, the ring waveguide 3, and the output waveguide 4 includes a core through which light propagates. The core is surrounded, i.e., covered, by cladding. The core is formed of, for example, Si. The cladding is formed of, for example, SiO₂. The refractive index of the material of which the core is formed and that of the material of which the cladding is formed are different from each other. The ring resonator 10 may be formed on an SOI (Silicon on Insulator) substrate including a BOX (Buried OXide) layer. In the case where the core is formed of Si and the cladding is formed of SiO₂, the difference between the refractive index of Si and that of SiO₂ is large. Therefore, the radius of the bending of each waveguide can be reduced to about 10 μm, so that the size of the ring resonator can be reduced.

The input waveguide 2 is optically connected to the ring waveguide 3. Light is input from one end of the input waveguide 2 (e.g., the left end in the drawing). A part of the input light propagates to the ring waveguide 3.

The ring waveguide 3 includes a waveguide part 31, a waveguide part 32, a waveguide part 33, and a waveguide part 34. The waveguide part 31, the waveguide part 32, and the waveguide part 33 correspond to the first waveguide part, the second waveguide part, and the third waveguide part, respectively. The waveguide part 31 is a part included in a region 91 of the ring waveguide 3. The input waveguide 2 and the ring waveguide 3 are optically connected to each other in the region 91. The waveguide part 32 is a part included in a region 92 of the ring waveguide 3. The ring waveguide 3 and the output waveguide 4 are optically connected to each other in the region 92.

The waveguide part 31 is optically connected to the input waveguide 2. The waveguide part 32 is optically connected to the output waveguide 4. Each of two curved waveguide parts connects the waveguide parts 31 and 32 to each other. A curved shape means, for example, a shape expressed by a line including a continuously curved section(s). The lengths of the two waveguide parts are different from each other. The waveguide part 33 is the longer one of the two waveguide parts. The waveguide part 34 is the shorter one of the two waveguide parts. Each of the waveguide parts 33 and 34 is physically and optically connected to both the waveguide parts 31 and 32.

Light input from the waveguide part 31 circulates, i.e., propagates in a circular shape, along the ring waveguide 3 in one direction (e.g., the counterclockwise direction in the drawing). Then, the light, i.e., parts of the light, having wavelengths equal or close to the resonant wavelength of the ring waveguide 3 propagates from the waveguide part 32 to the output waveguide 4.

An arrow 93 represents the direction along the waveguide part 31. An arrow 94 represents the direction along the waveguide part 32. The direction along the waveguide part 31 (also referred to as a first direction) and the direction along the waveguide part 32 (also referred to as a second direction) are not parallel to each other. The arrow 93 represents the first direction. The arrow 94 represents the second direction. The first and second directions may be perpendicular to each other.

The ring waveguide 3 has, for example, a racetrack shape. The racetrack shape consists of two parallel lines and two curves connecting the two parallel lines to each other. The two parallel lines are parallel to the first or second direction. The lengths of the two parallel lines are equal to each other. The two parallel lines shown in the drawing are parallel to the first direction. Note that in the example shown in FIG. 1, the waveguide part 31 is at least a part of one of the two parallel lines. Further, in the example shown in FIG. 1, the waveguide part 32 is at least a part of one of the two curves. Further, in the example shown in FIG. 1, the waveguide part 33 includes one of the two parallel lines and one of the two curves. In this case, the length of the waveguide that contributes to the coupling between the ring waveguide 3 and the output waveguide 4, i.e., the length of the straight-line waveguide that contributes to the coupling of the directional coupler, is relatively short. Note that the ring waveguide 3 may have a circular shape (e.g., a perfect-circular shape). Note that the aforementioned curves may be semicircular arcs.

The output waveguide 4 is optically connected to the waveguide part 32 of the ring waveguide 3. The output waveguide 4 outputs light from one end thereof (e.g., the upper end in the drawing).

The heater 5 and the thermal insulation structure 6 are arranged along the waveguide part 33 of the ring waveguide 3. The heater 5 and the thermal insulation structure 6 may be arranged along the entire waveguide part 33. The thermal insulation structure 6 is, for example, an air layer or a vacuum layer disposed below the ring waveguide 3 and the heater 5. By arranging the heater 5 and the thermal insulation structure 6, the electric power input to the heater 5 is reduced. The length of the part of the ring waveguide 3 along which the heater 5 is disposed may be, for example, a half or more of the circumference of the ring waveguide 3.

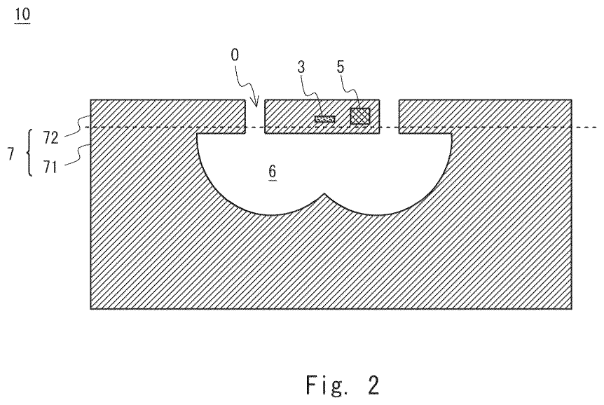

FIG. 2 schematically shows a first example of a cross-sectional view taken along a line A-A in FIG. 1. The ring resonator 10 includes a SiO₂ layer 7 formed on a substrate (not shown). The SiO₂ layer 7 may include a lower SiO₂ layer 71 disposed below the ring waveguide 3 and an upper SiO₂ layer 72 formed on the lower SiO₂ layer 71. The lower SiO₂ layer 71 may be, for example, a BOX layer of an SOI substrate. The ring waveguide 3 is formed of, for example, Si.

The heater 5 is disposed near the ring waveguide 3. Although the heater 5 is disposed on the side of the ring waveguide 3 in the drawing, the heater 5 may be disposed above or below the ring waveguide 3.

The heater 5 is formed of, for example, metal. When electric power is applied to the heater 5, the resonance wavelength of the ring waveguide 3 is shifted.

The thermal insulation structure 6 is an air layer disposed below the ring waveguide 3 in the drawing. The air layer is formed, for example, by etching the SiO₂ layer 7 disposed on both sides of the ring waveguide 3 in the depth direction, and thereby forming openings O, and then performing isotropic etching. The heater 5 is positioned between the openings O and the ring waveguide 3. The thermal insulation structure 6 covers the ring waveguide 3 and the heater 5 from below.

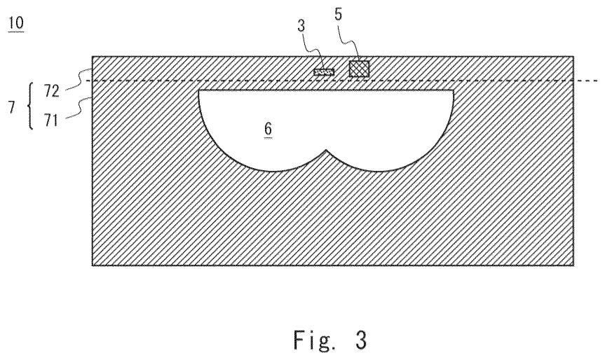

FIG. 3 schematically shows a second example of a cross-sectional view taken along the line A-A in FIG. 1. The thermal insulation structure 6 is a vacuum layer provided below the ring waveguide 3 in the drawing. The vacuum layer is formed, for example, before forming the upper SiO₂ layer 72, by etching the lower SiO₂ layer 71 on both sides of the ring waveguide 3 in the depth direction and then performing isotropic etching. The upper SiO₂ layer 72 may be formed on the lower SiO₂ layer 71 after the vacuum layer is formed.

Next, a problem to be solved by the present disclosure will be described in a concrete manner. It is known that when light having high optical intensity is input to the ring resonator 10, its transmission spectrum is distorted by a nonlinear phenomenon, so the optical intensity of the input light is restricted. As a result, the optical intensity of light output from the ring resonator 10 is also restricted. Incidentally, in the case where the heater 5 and the thermal insulation structure 6 are arranged along the ring waveguide 3, it is possible to realize a filtering function of the ring resonator 10 with low power consumption. However, when the heater 5 and the thermal insulation structure 6 are provided, there is a problem that a nonlinear phenomenon becomes apparent even at lower light power.

More specifically, when the core is formed of Si and the cladding is formed of SiO₂, the heating of the ring waveguide 3 is triggered by two-photon absorption, which is one of nonlinear phenomena. It is known that two-photon absorption does not occur in SiO₂ waveguides nor in Si₃N₄ waveguides, but occurs in Si waveguides. The thermal insulation structure 6 increases the change in the refractive index of the waveguide caused by the heating. Therefore, the shape of the transmission spectrum of the ring resonator 10 is significantly distorted. That is, there has been a trade-off between the reduction in power consumption achieved by providing the thermal insulation structure 6 and the distortion of the shape of the transmission spectrum due to the two-photon absorption.

Next, effects of the present disclosure will be described with reference to FIG. 1. Light that has propagated from the input waveguide 2 to the waveguide part 31 of the ring waveguide 3 is guided by the waveguide part 34, and a part of the light propagates from the waveguide part 32 to the output waveguide 4. Therefore, the optical intensity of the light guided by the waveguide part 33 has decreased to some extent. In this way, it is possible to prevent the nonlinear phenomenon caused by the heater 5 and the thermal insulation structure 6 from becoming apparent. Further, when the length of the waveguide part 33 in which the heater 5 and the thermal insulation structure 6 are arranged is sufficiently long, the power consumption is also reduced.

### Second Example Embodiment

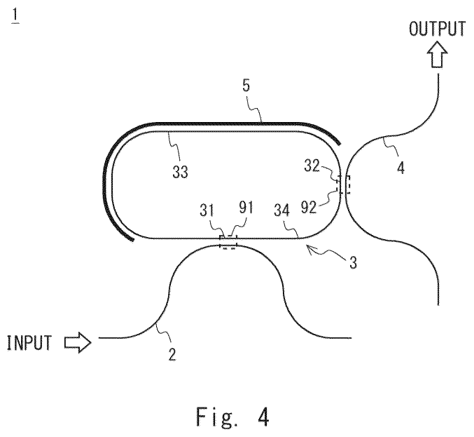

The configuration of the ring resonator 1 will be described with reference to FIG. 4. As can be seen from the comparison between FIGS. 1 and 4, the ring resonator 1 may not include the thermal insulation structure 6. It is sufficient if each waveguide is formed of a material that could cause a nonlinear optical phenomenon. The ring resonator 1 can prevent the nonlinear phenomenon from becoming apparent.

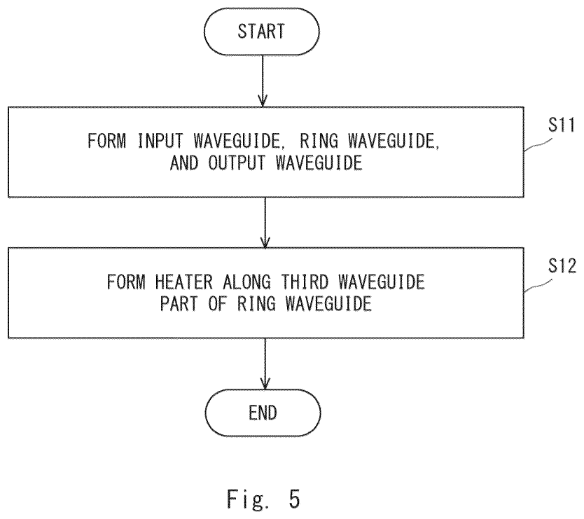

A method for manufacturing a ring resonator 1 will be described with reference to FIG. 5. In a step S11, an input waveguide 2, a ring waveguide 3, and an output waveguide 4 are formed. Each of the input waveguide 2, the ring waveguide 3, and the output waveguide 4 is formed, for example, by forming a resist pattern by lithography and etching an SOI substrate by using the formed resist as a photomask. An upper SiO₂ layer 72 may be formed after etching the SOI substrate.

In a step S12, a heater 5 is formed along the waveguide part 33 (third waveguide part) of the ring waveguide 3. The heater 5 may be formed, for example, by forming a resist pattern by lithography, and then forming a metal film and peeling the formed resist. Note that the heater 5 may be formed by etching the metal film after forming the metal film.

The order of the steps S11 and S12 may be reversed. Further, the method for manufacturing a ring resonator 1 may include forming a thermal insulation structure 6 along the waveguide part 33. The formation of the thermal insulation structure 6 may include forming an opening(s) in the SiO₂ layer by using a resist or the like as a photomask and performing isotropic etching after forming the opening(s).

By the manufacturing method shown in FIG. 5, it is possible to manufacture a ring resonator in which a nonlinear phenomenon is prevented from becoming apparent.

Although the present disclosure is described above with reference to example embodiments, the present disclosure is not limited to the above-described example embodiments. Various modifications that can be understood by those skilled in the art can be made to the configuration and details of the present disclosure within the scope of the disclosure. Further, the example embodiments may be combined with one another as appropriate.

Each of the drawings is merely an example for explaining one or more example embodiments. Each of the drawings is not associated with only one particular example embodiment, but may be associated with one or more other example embodiments. As will be appreciated by those skilled in the art, various features or steps described with reference to any one of the drawings may be combined with features or steps shown in one or more other figures to, for example, create an example embodiment that is not explicitly shown or described in the present disclosure. Not all of the features or steps shown in any one of the drawings are required to explain an example embodiment, and some of the features or steps may be omitted. The order of the steps described in any one of the drawings may be changed as appropriate.

Some or all of the elements (e.g., configuration and function) described in Supplementary notes 2 to 9 that are dependent on Supplementary notes 1 may be dependent on Supplementary notes 10 by the same dependency as Supplementary notes 2 to 9. Some or all of the elements described in any appendices may be applied to various hardware, software, recording means, systems, and methods for recording software.

The whole or part of the example embodiments disclosed above can be described as, but not limited to, the following supplementary notes.

### (Supplementary Note 1)

A ring resonator comprising:
an input waveguide;
an output waveguide; and
a ring waveguide including a first waveguide part optically connected to the input waveguide, a second waveguide part optically connected to the output waveguide, and two curved waveguide parts each connecting the first and second waveguide parts to each other, in which
lengths of the two waveguide parts are different from each other,
the ring resonator further comprises a heater disposed along a third waveguide part, the third waveguide part being a longer one of the two waveguide parts, and
a first direction along the first waveguide part and a second direction along the second waveguide part are not parallel to each other.

### (Supplementary Note 2)

The ring resonator described in Supplementary note 1, wherein the first and second directions are perpendicular to each other.

### (Supplementary Note 3)

The ring resonator described in Supplementary note 1 or 2, further comprising a thermal insulation structure disposed along the third waveguide part.

### (Supplementary Note 4)

The ring resonator described in Supplementary note 3, wherein the thermal insulation structure covers the ring waveguide and the heater from below.

### (Supplementary Note 5)

The ring resonator described in Supplementary note 1 or 2, wherein the ring waveguide includes a core formed of Si.

### (Supplementary Note 6)

The ring resonator described in Supplementary note 2, wherein
the ring waveguide comprises two parallel lines and two curves connecting the two parallel lines to each other,
the two parallel lines are parallel to the first or second direction, and
lengths of the two parallel lines are equal to each other.

### (Supplementary Note 7)

The ring resonator described in Supplementary note 6, wherein
the first waveguide part is at least a part of one of the two parallel lines, and
the second waveguide part is at least a part of one of the two curves.

### (Supplementary Note 8)

The ring resonator described in Supplementary note 6, wherein the third waveguide part includes one of the two parallel lines and one of the two curves.

### (Supplementary Note 9)

The ring resonator described in Supplementary note 1 or 2, wherein the heater is disposed along the entire third waveguide part.

### (Supplementary Note 10)

A method for manufacturing a ring resonator, comprising:
forming an input waveguide, a ring waveguide, and an output waveguide; and
forming a heater, wherein
the ring waveguide comprises a first waveguide part optically connected to the input waveguide, a second waveguide part optically connected to the output waveguide, and two waveguide parts each connecting the first and second waveguide parts to each other,
lengths of the two waveguide parts are different from each other,
a first direction along the first waveguide part and a second direction along the second waveguide part are not parallel to each other; and
the heater is formed along a third waveguide part, the third waveguide part being a longer one of the two waveguide parts.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A ring resonator comprising:
an input waveguide;
an output waveguide; and
a ring waveguide including a first waveguide part optically connected to the input waveguide, a second waveguide part optically connected to the output waveguide, and two curved waveguide parts each connecting the first and second waveguide parts to each other, in which
lengths of the two waveguide parts are different from each other,
the ring resonator further comprises a heater disposed along a third waveguide part, the third waveguide part being a longer one of the two waveguide parts, and
a first direction along the first waveguide part and a second direction along the second waveguide part are not parallel to each other.

2. The ring resonator according to claim 1, wherein the first and second directions are perpendicular to each other.

3. The ring resonator according to claim 1, further comprising a thermal insulation structure disposed along the third waveguide part.

4. The ring resonator according to claim 3, wherein the thermal insulation structure covers the ring waveguide and the heater from below.

5. The ring resonator according to claim 1, wherein the ring waveguide includes a core formed of Si.

6. The ring resonator according to claim 2, wherein
the ring waveguide comprises two parallel lines and two curves connecting the two parallel lines to each other,
the two parallel lines are parallel to the first or second direction, and
lengths of the two parallel lines are equal to each other.

7. The ring resonator according to claim 6, wherein
the first waveguide part is at least a part of one of the two parallel lines, and
the second waveguide part is at least a part of one of the two curves.

8. The ring resonator according to claim 6, wherein the third waveguide part includes one of the two parallel lines and one of the two curves.

9. The ring resonator according to claim 1, wherein the heater is disposed along the entire third waveguide part.

10. A method for manufacturing a ring resonator, comprising:
forming an input waveguide, a ring waveguide, and an output waveguide; and
forming a heater, wherein
the ring waveguide comprises a first waveguide part optically connected to the input waveguide, a second waveguide part optically connected to the output waveguide, and two curved waveguide parts each connecting the first and second waveguide parts to each other,
lengths of the two waveguide parts are different from each other,
a first direction along the first waveguide part and a second direction along the second waveguide part are not parallel to each other; and
the heater is formed along a third waveguide part, the third waveguide part being a longer one of the two waveguide parts.
